(19) United States
(12) Patent Application Publication
(10) Pub. No.: US 2006/0091776 A1
(43) Pub. Date: May 4, 2006

(54) Electron gun

(75) Inventors: Takatsugu Munehiro, Sagamihara-shi (JP); Akira Chiba, Sagamihara-shi (JP)

Correspondence Address: YOUNG & THOMPSON, 745 SOUTH 23RD STREET, 2ND FLOOR, ARLINGTON, VA, 22202, US

(73) Assignee: NEC MICROWAVE TUBE, LTD., SAGAMIHARA-SHI (JP)

(21) Appl. No.: 11/251,786

(22) Filed: Oct. 18, 2005

(30) Foreign Application Priority Data
Oct. 28, 2004 (JP) 2004-314232

(51) Int. Cl. H01J 1/20

(52) U.S. Cl. 313/337

(57) ABSTRACT

A disk-shaped cathode pellet is installed and secured by a retainer onto a heater cap that incorporates a heater. The part of this retainer that covers the periphery of the electron emission surface of the cathode pellet functions as a portion of a Wehnelt electrode. Alternatively, the retainer is formed such that the average angle of the surface with respect to the outermost shell of the electron beam matches the Pierce angle such that the part of this retainer that covers the periphery of the electron emission surface of the cathode pellet functions as a Wehnelt electrode.

### BACKGROUND OF THE INVENTION

1. Field of the Invention

The present invention relates to an electron gun that is used in a microwave tube such as a traveling-wave tube or a klystron, and more particularly to a Pierce type electron gun that is provided with a Wehnelt electrode for focusing an electron beam.

2. Description of the Related Art

Traveling-wave tubes and klystrons are electron tubes for amplifying high-frequency signals by means of the interaction between a high-frequency circuit and an electron beam that is emitted from an electron gun. Such electron tubes are constructions such as shown in FIG. 1 that include: electron gun 21 that emits electron beam 50; high-frequency circuit 22 for bringing about interaction between electron beam 50 that is emitted from electron gun 21 and high-frequency signals (microwaves); collector 23 for capturing electron beam 50 that is emitted from high-frequency circuit 22, and anode electrode 24 for guiding electron beam 50 that is emitted from electron gun 21 into high-frequency circuit 22.

Electron beam 50 that is emitted from electron gun 21 is accelerated by anode electrode 24 and guided into high-frequency circuit 22, and travels through the interior while interacting with a high-frequency signal that is applied as input from the input terminal of high-frequency circuit 22. Electron beam 50 that is supplied as output from the interior of high-frequency circuit 22 is captured by collector 23. At this time, the high-frequency signal that has been amplified by interaction with electron beam 50 is supplied as output from the output terminal of high-frequency circuit 22.

Electron guns 21 that are used in microwave tubes such as traveling-wave tubes and klystrons of this type are of many known types, one being the Pierce type electron gun that is provided with a Wehnelt electrode for focusing the electron beam.

FIG. 2 is a sectional side view showing the configuration of a Pierce type electron gun of the prior art.

As shown in FIG. 2, a Pierce type electron gun of the prior art is a configuration that is provided with: cathode pellet 11 for radiating thermions; heater 12 for applying thermal energy for causing cathode pellet 11 to radiate thermions; heater cap 13 for encapsulating heater 12; and Wehnelt electrode 14 for focusing the thermions and forming electron beam 50.

Heater cap 13 is a construction that is formed as a cylinder composed of molybdenum (Mo) with one sealed end, cathode pellet 11 being installed on the sealed surface.

Cathode pellet 11 is formed from a porous tungsten substrate that is impregnated with an oxide (emitter material) of barium (Ba), calcium (Ca), or aluminum (Al). Cathode pellet 11 is formed in approximately disk form that is convex in the axial direction of electron emission and that is provided with a stepped indentation around its periphery as seen in a section taken along the axis of emission of electrons, and has a shape such that the electron emission surface is processed to a flat or concave shape that is a portion of a spherical surface, and such that the surface on the side opposite the electron emission surface is flat. Cathode pellet 11 is secured onto heater cap 13 by the pressure against the above-described indentation toward the sealed surface that is exerted by retainer 15. A cathode pellet of this form is disclosed in, for example, JP-A-2003-346671.

Retainer 15 is formed in a cylindrical shape using a refractory metal such as tantalum (Ta), molybdenum (Mo), or molybdenum—rhenium (Mo—Re) alloy, the end of retainer 15 that is not in contact with the cathode pellet being bonded to heater cap 13 by welding or brazing and soldering following placement of the cathode pellet.

Wehnelt electrode 14 is formed in a donut shape that is provided with an opening in the center by machining metal such as molybdenum and is secured by welding or brazing and soldering to the rim of one of the openings in electron gun case 16, which is formed in a cylindrical shape.

Heater cap 13 to which cathode pellet 11 has been attached is supported inside electron gun case 16 by metal support members 17 that are composed of tantalum (Ta), molybdenum (Mo), molybdenum—rhenium alloy (Mo—Re), or iron—nickel—cobalt alloy (Kovar: Kv) and is secured at a position such that the electron emission surface of cathode pellet 11 and the surface of Wehnelt electrode 14 form substantially the same plane. In addition, the surface of Wehnelt electrode 14 on the side of anode electrode 24 is processed to a shape having an angle of 67.5° (referred to as the “Pierce angle”) with respect to the outermost shell of electron beam 50 (See FIG. 2).

In the Pierce type electron gun of the prior art that is shown in FIG. 2, the spacing of the cathode pellet and Wehnelt electrode, i.e., the perveance, must match a designed value with a high level of accuracy in order to focus electrons that are emitted from the cathode pellet to a desired beam diameter. It is further crucial to reduce divergence in the axial direction of electron emission between the electron emission surface of the cathode pellet and the surface of the Wehnelt electrode.

A large variation in the perveance or between the cathode pellet and the Wehnelt electrode in the axial direction of electron emission results in problems such as the collision of electrons that are emitted from the cathode pellet with the anode electrode, or fluctuation of the electron beam diameter in the high-frequency circuit that causes a portion of the electron beam to hit the high-frequency circuit. These problems bring about an increase in the power consumption or a reduction in the amplification performance of the microwave tube.

In addition, in the interest of reducing power consumption in an electron gun, the thermal energy produced by the heater is preferably efficiently transferred to the cathode pellet, and moreover, the heat that is conferred to the cathode pellet is preferably not diffused by way of the electron gun case or the Wehnelt electrode.

In the Pierce type electron gun of the prior art that is shown in FIG. 2, metal support members that are secured at positions remote from the cathode pellet are used to support the heater cap inside the electron gun case such that the thermal energy that is conferred from the heater to the cathode pellet is not diffused by the electron gun case or the Wehnelt electrode. Problems were therefore encountered because high-precision jigs and tools were required to weld and secure the heater cap in order to keep the perveance and variation in the axial direction of electron emission of the cathode pellet and Wehnelt electrode within prescribed values, and further, because a wide range of variation occurred in fabrication.

In addition, when the sectional form in the axial direction of electron emission of the cathode pellet is convex, electrons are emitted toward the outside from the part of the periphery of the cathode pellet that is not covered by the retainer (hereinbelow, referred to as “side emission”), and this gives rise to the previously described problems that electrons that are emitted from the cathode pellet hit the anode electrode, and the fluctuation in the diameter of the electron beam inside the high-frequency circuit causes a portion of the electron beam to hit the high-frequency circuit, thus preventing good electron emission characteristics from being obtained. As a result, the above-described high-precision jigs and tools were used to reduce the gap between the cathode pellet and Wehnelt electrode to a minimum, and the Wehnelt electrode was further arranged to precede the cathode surface (on the anode-electrode side) so as to focus electrons that have been radiated toward the outside.

In microwave communication in recent years, moreover, radiowaves of even higher frequencies are preferred for achieving higher volumes and more effective use of radiowaves. The size of microwave tubes has also decreased with this move toward higher-frequency waves, and electron guns are therefore now being fabricated in smaller sizes.

However, due to the convex sectional profile in the axial direction of electron emission of the cathode pellet in the Pierce type electron gun of the prior art that is shown in FIG. 2, the thickness of cathode pellet must be increased to a certain degree to withstand the securing force applied by the retainer. The weight of the cathode pellet increased as a consequence, and it was necessary to make the retainer thicker and stronger to secure the cathode pellet on the heater cap by brazing and soldering. This construction has therefore impeded the reduction of the size of the electron gun.

### SUMMARY OF THE INVENTION

It is therefore an object of the present invention to provide an electron gun that allows fewer individual differences that result from variations in fabrication, and moreover, that allows superior electron emission characteristics to be obtained.

In the present invention that can achieve the above-described object, the periphery of a disk-shaped cathode pellet is engaged with the heater cap by means of a retainer, whereby the cathode pellet is arranged and secured on the heater cap.

In addition, the cathode pellet is not only arranged and secured on the heater cap by means of the retainer, but the shape of the retainer is formed such that the average angle of the surface of the retainer with respect to the outermost shell of the electron beam matches the Pierce angle and such that the part of the retainer that covers the periphery of the electron emission surface of the cathode pellet functions as a Wehnelt electrode.

Because the part of the retainer that covers the periphery of the electron emission surface functions as a Wehnelt electrode in the above-described construction, the perveance and the divergence in the axial direction of electron emission between the electron emission surface of the cathode pellet and the retainer surface that functions as a Wehnelt electrode are uniform, and individual differences in the positional relation of the Wehnelt electrode and cathode pellet surface are reduced.

Thus, despite the occurrence of variations in fabrication in the gap between the retainer and the Wehnelt electrode that is arranged at the periphery of the retainer, influence upon the electrical field of the cathode pellet surface is reduced. In addition, side emission does not occur because the periphery of the cathode pellet is covered by the retainer. As a result, electron guns can be obtained that have excellent electron emission characteristics and in which individual differences are reduced.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a side sectional view showing an example of the configuration of a traveling-wave tube;

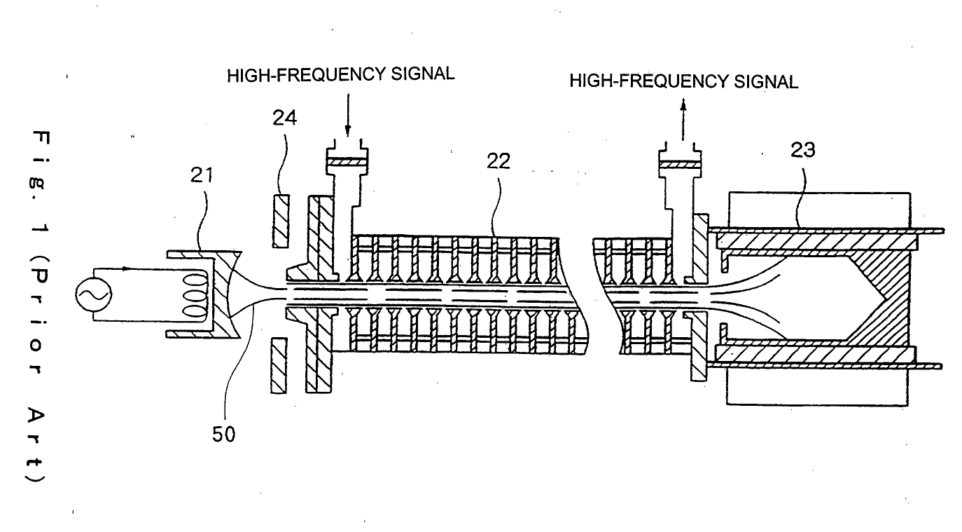

FIG. 2 is a side sectional view showing the configuration of an electron gun of the prior art;

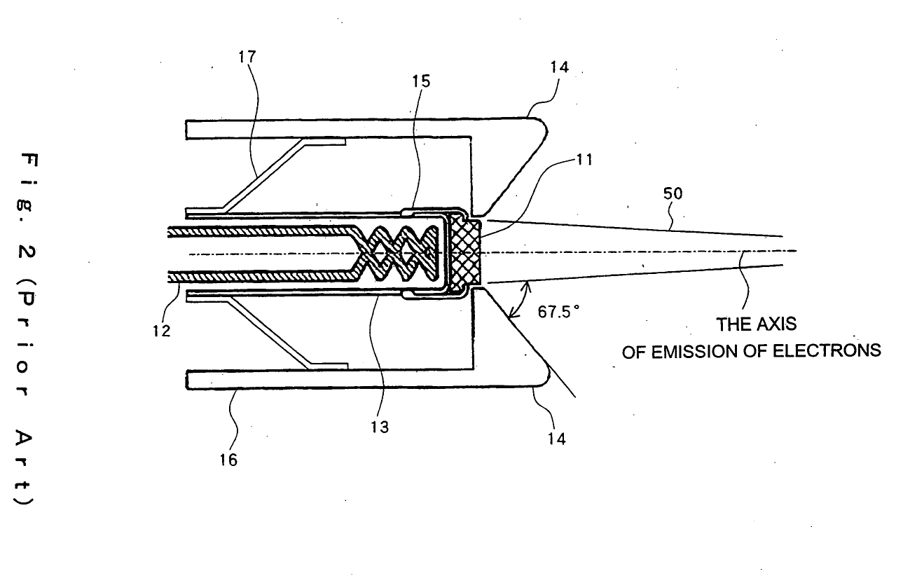

FIG. 3 is a side sectional view showing an example of the configuration of an electron gun of the present invention;

FIG. 4 is a side sectional view showing the configuration of a modification of the electron gun that is shown in FIG. 3, and

FIG. 5 is a side sectional view showing the configuration of another modification of the electron gun of the present invention.

### DETAILED DESCRIPTION OF THE PREFERRED EMBODIMENTS

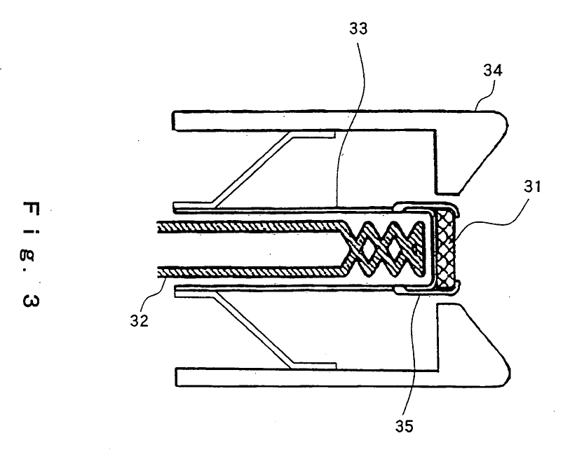

FIG. 3 is a sectional view showing an example of the configuration of an electron gun of the present invention.

As shown in FIG. 3, the electron gun of the present invention is a configuration in which cathode pellet 31 is formed in a disk shape and the periphery of cathode pellet 31 is engaged with and pressed against the sealed surface of heater cap 33 by means of retainer 35, whereby cathode pellet 31 is secured onto heater cap 33.

As with the prior art, cathode pellet 31 is secured at a position such that its electron emission surface and the surface of Wehnelt electrode 34 form approximately the same plane. Here, retainer 35 is a construction that protrudes by only its thickness with respect to the electron emission surface of cathode pellet 31. The construction is otherwise identical to an electron gun of the prior art and explanation of this construction is therefore here omitted.

In the electron gun of the present invention, the part of retainer 35 that covers the periphery of the electron emission surface of cathode pellet 31 is not only used as a securing member for securing cathode pellet 31 but also functions as Wehnelt electrode 34 for focusing electrons.

As previously described, in an electron gun of the prior art, the convex shape of the sectional form of the cathode pellet in the axial direction of electron emission results in an increase in the electric field strength at the periphery (edge portion). In addition, an electric field is not formed parallel to the surface of the cathode pellet, and electrons are therefore radiated toward the outside. As a result, electrons that were radiated toward the outside were focused by reducing the gap between the cathode pellet and Wehnelt electrode to the minimum, and further, by arranging the Wehnelt electrode to precede the cathode surface (on the anode electrode side).

In the electron gun of the present invention, the field strength at the edge portion of retainer 35 increases because the periphery (edge portion) of the electron emission surface of cathode pellet 31 is covered by retainer 35, but the laminar flow characteristic of the electron beam does not deteriorate because electrons are not radiated from retainer 35.

In the electron gun of the present invention, moreover, the positional relation of retainer 35 that functions as Wehnelt electrode 34 and the surface of cathode pellet 31 is fixed, and the perveance and divergence in the axial direction of electron emission between the electron emission surface of cathode pellet 31 and the surface of the surface of Wehnelt electrode 34 are also fixed.

The field strength of the periphery of cathode pellet 31 is determined substantially by the positional relation with retainer 35 and therefore is virtually unchanged. In addition, side emission therefore does not occur because the periphery of cathode pellet 31 is covered by retainer 35. The reduction of individual differences in the positional relation of retainer 35 and the surface of cathode pellet 31 results in a reduction of the influence exerted upon the electric field of the surface of cathode pellet 31 despite fabrication variations in the gap between retainer 35 and Wehnelt electrode 34 that is arranged at the periphery of retainer 35. Accordingly, electron guns can be obtained in which individual differences are limited and that are provided with excellent electron emission characteristics.

In the electron gun of the present invention, moreover, cathode pellet 31 is formed in a disk shape, and the thickness of cathode pellet 31 in the axial direction of electron emission can therefore be reduced from that of the prior art. The heat capacity of cathode pellet 31 is thus reduced and the heat conductivity from heater 32 to cathode pellet 31 is improved. The device will thus function with less heater power, whereby the power consumption of the microwave tube can be reduced. In addition, the thermal response speed can be accelerated, and the start-up time from the introduction of the power supply to the operation of the electron gun can therefore be shortened.

In the electron gun of the present invention, moreover, when the thickness of retainer 35 is made greater than 0.2 mm, or when the thickness of retainer 35 is greater than approximately 10% of the diameter of the cathode pellet, the electric field strength becomes non-uniform from the central portion to the peripheral portion of the surface of cathode pellet 31, whereby the concern arises that electrons of the peripheral portion of cathode pellet 31 will be radiated toward the central portion and the laminar flow characteristic of the electron beam cannot be maintained. The thickness of retainer 35 therefore preferably meets one of the conditions of being less than 0.2 mm or being less than 10% of the diameter of cathode pellet 31. The thickness of retainer 35 need only be sufficient to provide the strength to secure cathode pellet 31, and a thinner and lighter cathode pellet 31 facilitates the reduced thickness of retainer 35.

In the electron gun of the present invention, moreover, if the Pierce angle (67.5°) is realized as the average angle, with respect to the electron beam, of the part of retainer 35 that functions as Wehnelt electrode 34 and the surface of Wehnelt electrode 34, no particular limitation need be placed on the surface area of cathode pellet 31 that is covered by retainer 35. However, too much coverage of the surface of cathode pellet 31 by retainer 35 interferes with the effective use of cathode pellet 31. On the other hand, insufficient coverage of the surface of cathode pellet 31 by retainer 35 diminishes the function of retainer 35 as Wehnelt electrode 34. Accordingly, the inner diameter of retainer 35 that covers the periphery of the surface of cathode pellet 31 is preferably approximately 90% of the diameter of cathode pellet 31.

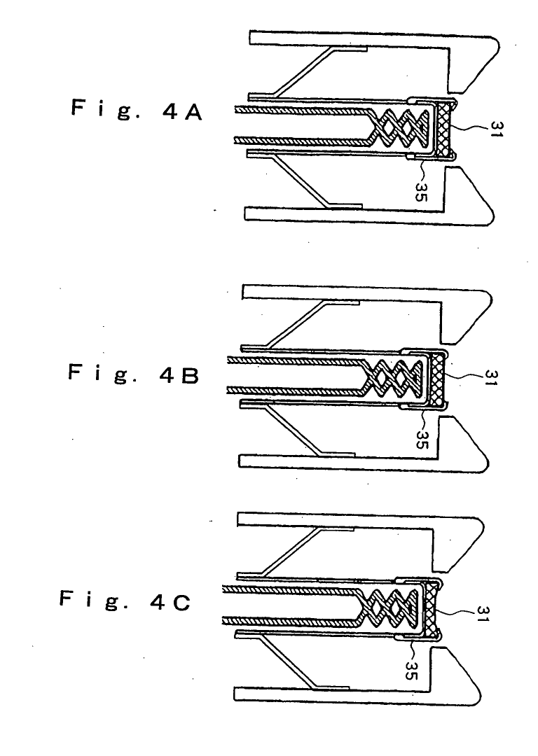

As previously described, retainer 35 is formed from a thin refractory metal plate that is composed of, for example, tantalum (Ta), molybdenum (Mo), or molybdenum—rhenium alloy (Mo—Re). On the other hand, tungsten is used as the main material of cathode pellet 31, as previously described. The difference between the thermal expansion coefficient of retainer 35 and the thermal expansion coefficient of cathode pellet 31 is not great, and the difference in thermal expansion coefficients causes virtually no decrease in the fixed strength of cathode pellet 31 due to retainer 35. However, to prevent even a slight decrease of strength, the end of retainer 35 that contacts cathode pellet 31 should be processed to a turned-back shape as shown in FIG. 4A or an arc shape as shown in FIG. 4B.

In addition, the electron emission surface of cathode pellet 31 need not be flat as shown in FIG. 3, but may be processed to a concave shape that forms a portion of a sphere as shown in FIG. 4C. In such a case, the end of retainer 35 that contacts cathode pellet 31 should be a turned-back shape as shown in FIG. 4A, an arc shape as shown in FIG. 4B, or a shape that is bent to an angle more acute than 90° with respect to the concave surface.

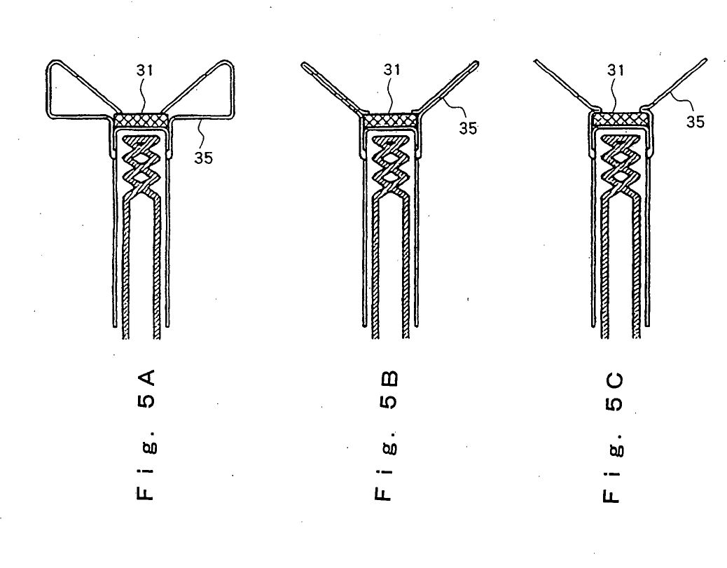

As previously described, retainer 35 functions as Wehnelt electrode 34 in the present invention, but this fact shows that any configuration is possible as long as the average angle of the part of retainer 35 that functions as Wehnelt electrode 34 and the surface of Wehnelt electrode 34 have the Pierce angle with respect to the electron beam. In other words, the Wehnelt electrode function of retainer 35 may be realized by forming retainer 35 on the electron emission surface side of cathode pellet 31 as a funnel shape or as a shape that includes a funnel shape as shown in FIGS. 5A-C. In such a case, Wehnelt electrode 34 is unnecessary.

According to the electron gun of the present invention, the part of retainer 35 that covers the periphery of the electron emission surface functions as Wehnelt electrode 34, thereby fixing the perveance and the divergence in the axial direction of electron emission of the electron emission surface of cathode pellet 31 and the surface of the retainer that functions as Wehnelt electrode 34, and reducing individual differences in the positional relation between Wehnelt electrode 34 that is formed by retainer 35 and the surface of cathode pellet 31. As a result, influence upon the electric field of the surface of cathode pellet 31 is reduced despite the occurrence of variations in fabrication of the spacing between Wehnelt electrode 34 that is arranged on the periphery of retainer 35 and retainer 35. Further, side emission does not occur because the periphery of cathode pellet 31 is covered by retainer 35. As a result, electron guns can be obtained that have fewer individual differences and that are provided with excellent electron emission characteristics.

While preferred embodiments of the present invention have been described using specific terms, such description is for illustrative purposes only, and it is to be understood that changes and variations may be made without departing from the spirit or scope of the following claims.

What is claimed is:

1. An electron gun comprising:
a cathode pellet for emitting electrons;
a heater cap that incorporates a heater for imparting to said cathode pellet thermal energy for causing the emission of electrons;
a Wehnelt electrode for focusing an electron beam that is formed such that an average angle of its surface with respect to an outermost shell of said electron beam matches the Pierce angle; and
a retainer for engaging and holding a periphery of said cathode pellet to said heater cap to install and secure said cathode pellet on said heater cap, wherein a part of said retainer that covers a periphery of an electron emission surface of said cathode pellet further functions as a portion of said Wehnelt electrode.

2. An electron gun, comprising:
a cathode pellet for emitting electrons;
a heater cap that incorporates a heater for imparting to said cathode pellet thermal energy for causing the emission of electrons; and
a retainer for engaging and holding a periphery of said cathode pellet to said heater cap to install and secure said cathode pellet on said heater cap, wherein a part of said retainer that covers the periphery of an electron emission surface of said cathode pellet is formed such that the average angle of a surface of said retainer with respect to an outermost shell of an electron beam matches the Pierce angle so as to further function as a Wehnelt electrode for focusing said electron beam.

3. The electron gun according to claim 1, wherein said cathode pellet is a disk shape.

4. The electron gun according to claim 2, wherein said cathode pellet is a disk shape.

5. The electron gun according to claim 1, wherein a thickness of said retainer satisfies at least one of two conditions that:
said thickness is no greater than 0.2 mm; and said thickness is no greater than 10% of a diameter of said cathode pellet.

6. The electron gun according to claim 2, wherein a thickness of said retainer satisfies at least one of two conditions that:
said thickness is no greater than 0.2 mm; and said thickness is no greater than 10% of a diameter of said cathode pellet.

7. The electron gun according to claim 1, wherein an inner diameter of the part that covers the periphery of the electron emission surface of said cathode pellet is 90% of the diameter of said cathode pellet.

8. The electron gun according to claim 2, wherein an inner diameter of the part that covers the periphery of the electron emission surface of said cathode pellet is 90% of the diameter of said cathode pellet.

9. The electron gun according to claim 1, wherein said retainer is formed in a shape in which an end of said retainer that contacts said cathode pellet is bent back such that the periphery of said cathode pellet is pressed against said heater cap.

10. The electron gun according to claim 2, wherein said retainer is formed in a shape in which an end of said retainer that contacts said cathode pellet is bent back such that the periphery of said cathode pellet is pressed against said heater cap.

11. The electron gun according to claim 1, wherein said retainer is formed in a shape in which an end of said retainer that contacts said cathode pellet is an arc shape such that the periphery of said cathode pellet is pressed against said heater cap.

12. The electron gun according to claim 2, wherein said retainer is formed in a shape in which an end of said retainer that contacts said cathode pellet is an arc shape such that the periphery of said cathode pellet is pressed against said heater cap.
